(19) United States
(12) Patent Application Publication
(10) Pub. No.: US 2020/0132427 A1
(43) Pub. Date: Apr. 30, 2020

(54) SEGMENTED, COMBINATION LEVEL AND SQUARE, HAVING SLIDING AND/OR MAGNETIC JOINT

(71) Applicant: Timothy Lewis Harrington, Thomaston, ME (US)

(72) Inventor: Timothy Lewis Harrington, Thomaston, ME (US)

(21) Appl. No.: 16/176,935

(22) Filed: Oct. 31, 2018

(51) Int. Cl. G01B 3/56; G01C 9/28; G01B 3/04; G01B 3/00

(52) U.S. Cl. CPC G01B 3/566; G01B 3/002; G01B 3/04; G01C 9/28

(57) ABSTRACT

The present invention relates to a segmented, combination level and square that has a sliding and/or magnetic joint. In a preferred embodiment, this hand tool provides the user with many optional tools in one. The tool can be configured as a spirit level, framing square or a pocket square. In a preferred embodiment, this multi-segmented combination tool also provides the user with a convenient way not only to configure a level, in one inch increments, to any length from twelve inches to at least ninety six inches in length, but also to create more than one tool at a time such as a pocket square and a framing square. In other preferred embodiments, the user is provided with optional features that enable them to carry on-site a single tool that can perform all tasks to do general construction layout such as roof framing.

Provisional application—62/594,512—Received on 04 Dec. 2017

### REFERENCES CITED

U.S. Patent Documents

| | | |
|---|---|---|
| 320718 | June 1885 | Steers |
| 397128 | February 1889 | Hester |
| 451659 | May 1891 | Hatcher |
| 715897 | December 1902 | Streed |
| 4446627 | May 1984 | Persson |
| 4920658 | May 1990 | Hile |
| 5020233 | June 1991 | Syken |
| 5839201 | November 1998 | Young |

### DESCRIPTION

The present invention relates to a segmented, combination level and square that has a sliding joint or magnetic joint OR a combination of both a sliding and a magnetic joint. In a preferred embodiment, this hand tool provides the user with many optional tools in one. The tool can be configured as a spirit level, pocket square and a framing square. In a preferred embodiment, the multi-segmented combination level tool also provides the user with a convenient way not only to configure a level from a straight level in one inch increments and can be configured to any length from several inches to at least eight feet in length, but also to create more than one tool at a time such as a Carpenters square or a Pocket square. In all the preferred embodiments, the user is provided with optional features that enable them to carry on-site a single tool that can perform all tasks need to do general construction layout including roof framing.

### BACKGROUND

In the past, a person doing construction layout work had to carry a number of hand tools to the work site. At least one straight edge spirit level was necessary to determine the level of the work, as well as to serve as a rule or straight edge. Most workers carry more than one depending on the length required and the accuracy of the work to be done. A pocket square enables the user to determine and mark perpendiculars and check for 90 degree angles. A framing square can check for 90 degree angles and enables the user to set roof pitches. Therefore, if the worker has to climb a latter, they would have to make multiple trips and carry many different tools with them.

### SUMMARY OF THE INVENTION

The present invention relates to a segmented, combination level and square that has a sliding and/or magnetic joint means. This hand tool provides the user with many optional tools in one. The sliding joint can be strictly mechanical or incorporate magnets to align and strengthen the joint. With the sliding joint means set to zero degrees between the first level segment and a second level segment, the tool is straight spirit level. Change the sliding or magnetic joint means to ninety degrees by joining two forty five degree angles and the tool is a framing square or a pocket square. Level segments can vary in length such that smaller level segments are the length of torpedo level and they can be combined to form a pocket square. Therefore the present invention can offer the worker one tool to carry up a ladder, do general layout work and perform at the work of at least four ordinary hand tools.

The segmented combination tool is comprised of at least a first level segment with at least one end consisting of a forty five degree angle and a second level segment with at least one end consisting of a forty five degree angle connected by a sliding or magnetic joint or both. The first level segment has at least a first straight surface, a distal end, a proximal end and a level indicating means disposed thereon with respect to the straight surface. One or both ends of the first level segment has a forty five degree angle with a male or female appendage. The second level segment has at least a first straight surface which is oriented in the same plane as the first straight surface of the first level segment, a distal end, and a proximal end. Typically, each level segment has rectangular cross section having straight surfaces on the top, bottom and lateral exterior sides. The sliding and/or magnetic joint means is disposed between the proximal end of the first level segment and proximal end of the second level segment. The sliding and/or magnetic joint connects the first level segment and second level segment. When the segments join and their respective straight level surfaces line up in the same plane with a zero degree angle between the two forty five degree ends the tool forms a straight spirit level. When the sliding and/or magnetic joint connects the first level segment and second level segment at a ninety degree angle the tool becomes a framing square or a pocket square.

### BRIEF DESCRIPTION OF THE DRAWINGS

FIG. 1 is a sectional view of an embodiment of the present combination tool as set up to function as a straight spirit level.

FIG. 2 is a sectional view of an embodiment of the present combination tool as set up as a pocket square or a framing square.

FIG. 3 is a sectional view showing the present invention as a multi-segmented level.

FIG. 4 is a sectional view of an embodiment of the present combination tool female joint.

FIG. 5 is a sectional view of an embodiment of the present combination tool male joint.

### DETAILED DESCRIPTION OF THE INVENTION

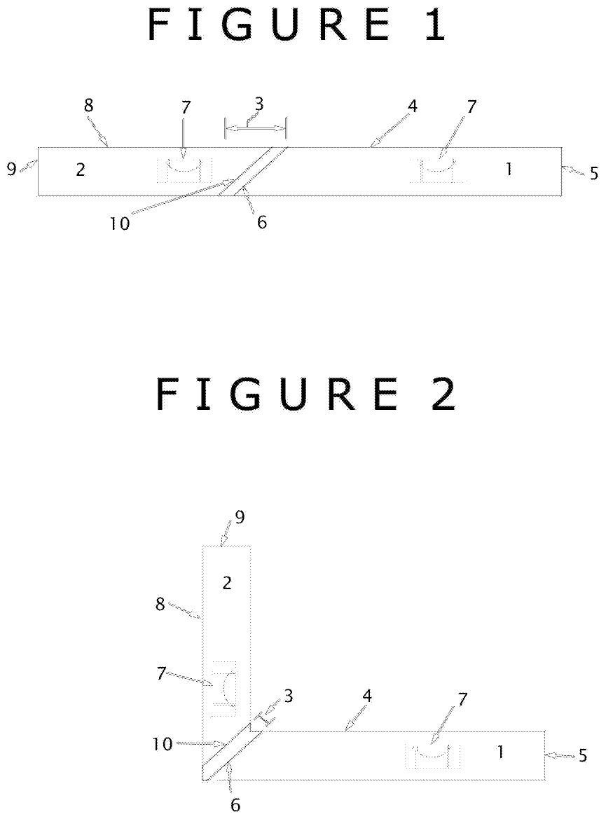

A preferred embodiment of the present segmented combination tool is shown in FIG. 1, set up to function as a straight spirit level. The tool is comprised of at least a first level segment (1), a second level segment (2), and a sliding and/or magnetic joint means (3) connecting the two segments. The first level segment has at least a first straight surface (4), a distal end (5), a proximal end (6) angled at forty five degrees (11), and a level indicating means (7), such as a spirit level attached to the first level segment by conventional means, disposed thereon with respect to the first straight surface. The second level segment has at least a first straight surface (8) which is oriented in the same plane as the first straight surface of the first level segment, a distal end (9), and a proximal end (10). Typically, the level segments have a rectangular cross-section and have a top, bottom, and lateral exterior side surfaces which are all straight. The sliding and/or magnetic joint means (3) is disposed between the proximal end of the first level segment (6) and the proximal end of the second level segment (10). The sliding and/or magnetic joint means connects the first level segment and second level segment such that the first straight surfaces thereon can for form a angular relationship of zero degrees for FIG. 1 and ninety degrees for FIG. 2. Noteworthy is the forty five degree angle at the proximal end of the first level segment (1) and the forty five degree angle at the proximal end of the second level segment (2) combine to form a zero degree angle to form a straight spirit level in FIG. 1 and combine to form a ninety degree angle in FIG. 2 to form a framing square or pocket square.

Preferably, the sliding and/or magnetic joint means is dimensioned and configured such that the female coupling member and the male coupling member can be separated. The first level segment, having the first portion of the sliding and/or magnetic joint means on the proximal end thereof, which is either a male coupling member or a female coupling member, can be detached the second level segment, have a second portion of the sliding and/or magnet means on the proximal end thereof, which is a male coupling member or a female coupling member complementary to the first portion.

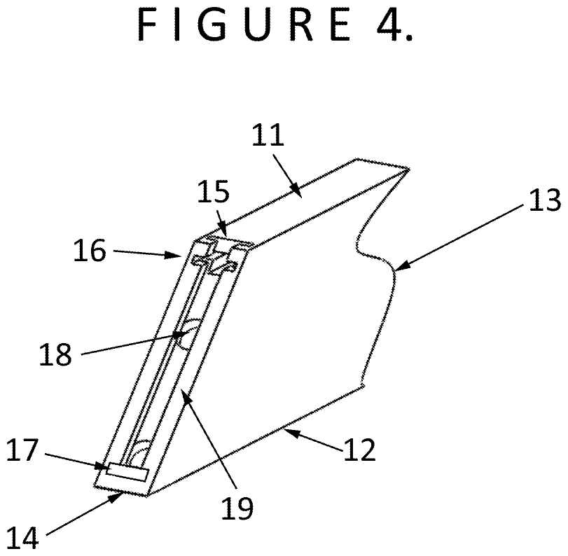

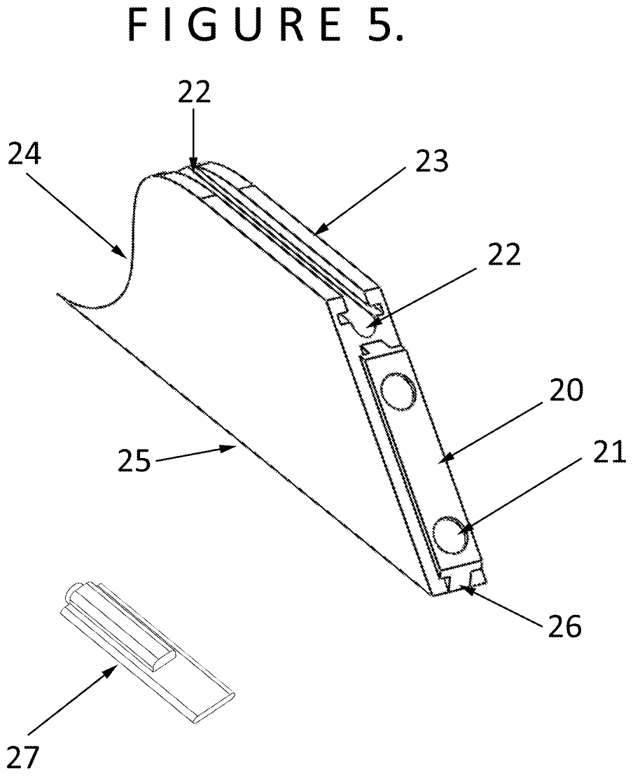

A preferred embodiment of the sliding and or magnetic joint as shown in FIG. 1 item (3) and FIG. 2 item (3) is further expanded upon in FIG. 4, female joint and FIG. 5 male joint. The male joint (FIG. 5) combines and is enjoined with the female joint (FIG. 4). As shown in FIG. 4 the female coupling member has a top (11), a bottom (12), a distal end (13) and a proximal end (14). The proximal end of the female coupling member is dimensioned and configured to be a 45 degree angle from bottom (12) to top (11). The female member in FIG. 4 has a Tee shaped receiving slot (15). The Tee shape receiving slot is a preferred embodiment but any geometry that serves as a receiving slot may be used. The receiving slot is not limited to a Tee shape. As shown in FIG. 5 the male coupling member has a top (23), a bottom (25), a distal end (24) and a proximal end (26). The proximal end of the male coupling joint is dimensioned and configured to be a 45 degree angle from bottom (25) to top (23). In a preferred embodiment in FIG. 5 a protruding Tee shaped member (20) is affixed or enjoined to the proximal end (26) of the male coupling member. The Tee shape protruding member is a preferred embodiment but any geometry that serves as a protruding member may be used and the protruding member is not limited to a Tee shape. Another preferred embodiment on FIGS. 4 and 5 is to embed or join magnets into or onto flat surfaces without a sliding means of locking the joint on the 45 degree angles in FIGS. 4 and 5. When the magnets from FIGS. 4 and 5 attract on the smooth 45 degree surfaces and joined, a straight spirit level embodiment in FIG. 1 and a 90 degree Spirit level or 90 degree Square in FIG. 2 are the results. Other embodiments of the male and female joint locking, aligning and connecting means are not presented here which are obvious to those of ordinary skill in the art, now or during the term of any patent issuing from this patent specification.

A secondary means of locking the male (FIG. 5.) and female (FIG. 4.) coupling members may be used. One of embodiment of such a design is shown on FIG. 5 (27). The locking tab (27) inserts in the receiving channel (22) of the male coupling member along the top (23). The locking tab (27) uses a mechanical force applied by the user or uses a source of potential energy such as a spring to assist the movement of the locking tab (27). Other embodiments of the locking tab device means are not presented here which are obvious to those of ordinary skill in the art, now or during the term of any patent issuing from this patent specification. The female member (FIG. 4.) has two receiving slots (16 and 17). After the male protruding member (20) in FIG. 5 is fully inserted into the female receiving slot (15) in FIG. 4, the locking tab (27) slides inside the channel (22) and enters receiving slot (16), the proximal ends of FIGS. 4 (14) and 5 (26) are joined, aligned and locked forming a Square or a spirit level with a 90 degree embodiment (FIG. 2.) After the male protruding member (20) in FIG. 5 is fully inserted into the female receiving slot (15) in FIG. 4, the locking tab (27) slides inside the channel (22) and enters the receiving slot (17), the proximal ends of FIGS. 4 (13) and 5 (26) are joined, aligned and locked forming a spirit level embodiment shown in FIG. 1.

In a preferred embodiment the Male and Female joint members shown if FIGS. 4 and 5 have magnets embedded into each member to provide attractive force and in some cases repellent force. In a preferred embodiment in FIG. 4 the magnets (18) are round tubular rare earth magnets with epoxy coating and are embedded in the receiving slot (15). In FIG. 5 the magnets (21) are embedded in the protruding Tee bar. Other embodiments of the magnets type, dimensions, placement and magnetic force means are not presented here which are obvious to those of ordinary skill in the art, now or during the term of any patent issuing from this patent specification.

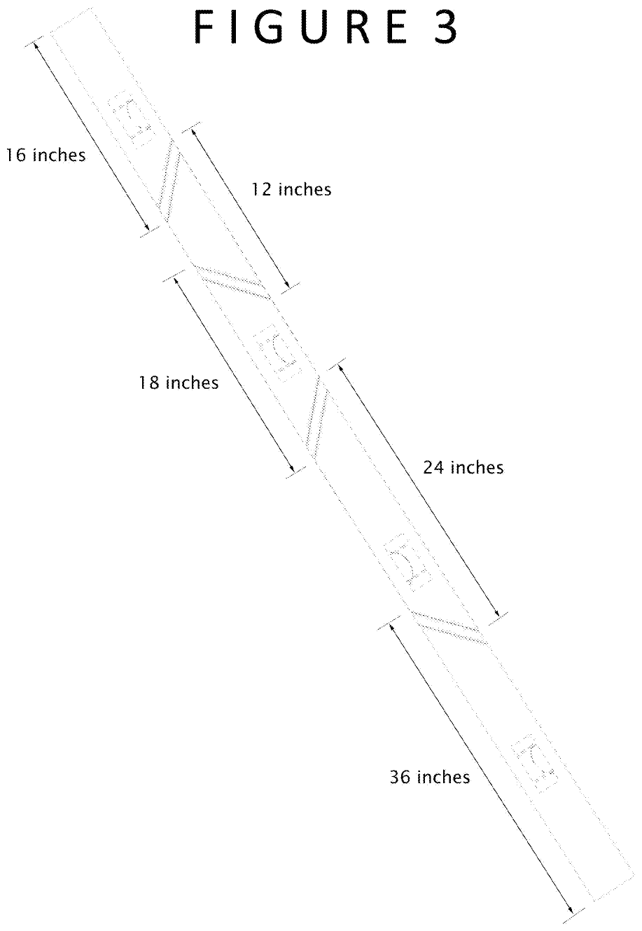

As shown in FIG. 3, each level segment has four straight surfaces and a rectangular cross-section. Typically, each level segment would have a width across the top or first straight surface (4) of about one to one and a half inches and height on a later exterior surface of about two inches to three and one half inches.

In preferred embodiments, the length of the present combination tool can be adjusted by adding or subtracting additional level segments of varying lengths. Some or all of the level can have level indicating means incorporated therein. In such cases, the tool comprises a plurality of level segments, at least two of the level segments being joined in a sliding and/or magnetic joint means. Of course, one can incorporate sliding and/or magnetic joint means between every pair of adjacent level segment ends as seen in FIG. 3.

The level segments can be selected to have varying lengths that enable the user to construct the present invention in a variety of tool lengths and configurations. For example, if using the English measurement system can comprise a level consisting of over one hundred inches, comprised of five level segments with a plurality of level indicating means as shown in FIG. 3. A first level segment is thirty six inches. A second level segment is twenty four inches. A third level segment is eighteen inches. A fourth level segment is twelve inches. A fifth level segment is sixteen inches. The twenty four, eighteen inch and twelve inch segments have a proximal end with a first portion of a separable sliding and/or magnetic joint means and a distal end with a complementary second portion of a separable sliding and/or magnetic joint. The first level segment that is thirty six inches and the fifth level segment that is sixteen inches long, have a proximal end with a first portion of a separable sliding and/or magnetic joint means and a distal end that may or may not have a complementary second portion of a separable sliding and/or magnetic joint. FIGS. 1 and 2 show the thirty six inch segment and the sixteen inch segment distal ends with no separable sliding and/or magnetic joint means.

Together these elements form a level that is greater than one hundred inches and the level is large enough for the great majority of construction layout tasks. By assembling a lesser number of level segments in varying combinations, one can have a level twelve inches to over one hundred inches. For storage, the level can be joined into a variety of shorter lengths.

The level segments can be machined, molded, extruded, or otherwise constructed from a variety of materials, including conventional hardwood/brass configurations, aluminum, stainless steel or plastics such as reinforced nylon, delrin, zytel, polyethylene, polycarbonate, ABS, high impact polystyrene, polypropylene and many others. The male coupling members and the female coupling members can either be integral with the level segments or be separate parts that are secured to the level segment ends either by fasteners or a snap-on, compression fitting. In a preferred embodiment, the level segments are made by cutting to length from an extruded reinforced plastic or aluminum length which has had an opening for mounting a spirit level punched out at regular lengths. The female coupling members and male coupling members are molded plastic.

Injection molded segments with female and male coupling members integral with the segments with indentations to install rare earth magnets is another embodiment. The ordinary skilled artisan can appreciate that the present invention can incorporate any number of preferred features described above.

All publications or unpublished patent applications mentioned herein are hereby incorporated by reference thereto.

Other embodiments of the present invention are not presented here which are obvious to those of ordinary skill in the art, now or during the term of any patent issuing from this patent specification, and thus, are within the spirit and scope of the present invention.

I claim:

1. A level comprised of:
a) at least a first level segment having at least a first straight surface, a distal end, a proximal end, and a level indicating means disposed thereon with respect to the straight surface;
b) a second level segment having at least a first straight surface with is oriented in the same plane as the first straight surface of the first level segment, a distal end, and a proximal end; and
c) a sliding and/or magnetic joint means disposed between the proximal end of the first level segment and the proximal end of the second level segment which connects the first level segment and the second level segment such that the first straight surfaces thereon can form a locking angular relationship of zero degrees in the first position making the invention a straight spirit level and ninety degrees in the second position thus making the invention a carpenters square, and wherein the sliding and/or magnetic joint means is comprised of a first portion and a second portion, the first portion being disposed on the first level segment, being separable from the second portion which is disposed on the second level segment without removing any element from either the first portion or the second portion of the sliding and/or magnetic joint means.

2. A square comprised of:
a) at least a first square segment having at least a first straight surface, a distal end, a proximal end, and a level indicating means disposed thereon with respect to the straight surface;
b) a second square segment having at least a first straight surface with is oriented in the same plane as the first straight surface of the first square segment, a distal end, and a proximal end; and
c) a sliding and/or magnetic joint means disposed between the proximal end of the first square segment and the proximal end of the second square segment which connects the first level segment and the second level segment such that the first straight surfaces thereon can form a locking angular relationship of zero degrees in the first position and 90 degrees in the second position, and wherein the sliding and/or magnetic joint means is comprised of a first portion and a second portion, the first portion being disposed on the first square segment, being separable from the second portion which is disposed on the second level segment without removing any element from either the first portion or the second portion of the sliding and/or magnetic joint means.
